(19) United States
(12) Patent Application Publication
(10) Pub. No.: US 2017/0282747 A1
(43) Pub. Date: Oct. 5, 2017

(54) CHARGING SYSTEM FOR VEHICLE BATTERY

(71) Applicant: Ford Global Technologies, LLC, Dearborn, MI (US)

(72) Inventor: Chih-Lun WANG, Canton, MI (US)

(21) Appl. No.: 15/090,714

(22) Filed: Apr. 5, 2016

(51) Int. Cl. B60L 11/18

(52) U.S. Cl. CPC B60L 11/1868; B60L 11/1811

(57) ABSTRACT

A vehicle power system includes circuitry including a transformer having a single primary coil and at least two secondary coils electrically isolated from one another, one of the secondary coils being electrically connected to a traction battery and another of the secondary coils being electrically connected to an auxiliary battery, and a controller configured to operate the circuitry to transfer power from the primary coil to each of the batteries at a same time.

### TECHNICAL FIELD

The present disclosure relates to systems and methods for charging a traction battery and an auxiliary battery of a vehicle.

### BACKGROUND

The term “electric vehicle” can be used to describe vehicles having at least one electric motor for vehicle propulsion, such as battery electric vehicles (BEV), hybrid electric vehicles (HEV), and plug-in hybrid electric vehicles (PHEV). A BEV includes at least one electric motor, wherein the energy source for the motor is a battery that is re-chargeable from an external electric grid. An HEV includes an internal combustion engine and one or more electric motors, wherein the energy source for the engine is fuel and the energy source for the motor is a battery. In an HEV, the engine is the main source of energy for vehicle propulsion with the battery providing supplemental energy for vehicle propulsion (the battery buffers fuel energy and recovers kinetic energy in electric form). A PHEV is like an HEV, but the PHEV has a larger capacity battery that is rechargeable from the external electric grid. In a PHEV, the battery is the main source of energy for vehicle propulsion until the battery depletes to a low energy level, at which time the PHEV operates like an HEV for vehicle propulsion.

### SUMMARY

A vehicle power system includes circuitry including a transformer having a single primary coil and at least two secondary coils electrically isolated from one another, one of the secondary coils being electrically connected to a traction battery and another of the secondary coils being electrically connected to an auxiliary battery, and a controller configured to operate the circuitry to transfer power from the primary coil to each of the batteries at a same time.

A method for charging batteries of a vehicle includes cycling (i) switches electrically connected between a power source remote from the vehicle and a transformer having a single primary coil and at least two secondary coils electrically isolated from one another, one of the secondary coils being electrically connected to a traction battery and another of the secondary coils being electrically connected to an auxiliary battery, and (ii) switches electrically connected between the another of the secondary coils and the auxiliary battery to transfer power from the primary coil to each of the batteries at a same time.

A vehicle power system includes a transformer having a single input and dual outputs electrically isolated from each other, a traction battery electrically connected to one of the outputs, and an auxiliary battery electrically connected to the other of the outputs, wherein the transformer is configured to transfer power from the input to each of the outputs at a same time.

### BRIEF DESCRIPTION OF THE DRAWINGS

FIG. 1 is a block diagram illustrating an electrified vehicle;

FIG. 2 is a block diagram illustrating a traction battery charging system;

FIG. 3 is a schematic diagram illustrating the traction battery charging system;

FIG. 4 is a block diagram illustrating an auxiliary battery charging system;

FIG. 5 is a schematic diagram illustrating the auxiliary battery charging system;

FIG. 6 is a block diagram illustrating an integrated charging system;

FIG. 7 is schematic diagram illustrating the integrated charging system; and

FIG. 8 is a flowchart illustrating an algorithm for integrated charging of the traction battery and the auxiliary battery.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

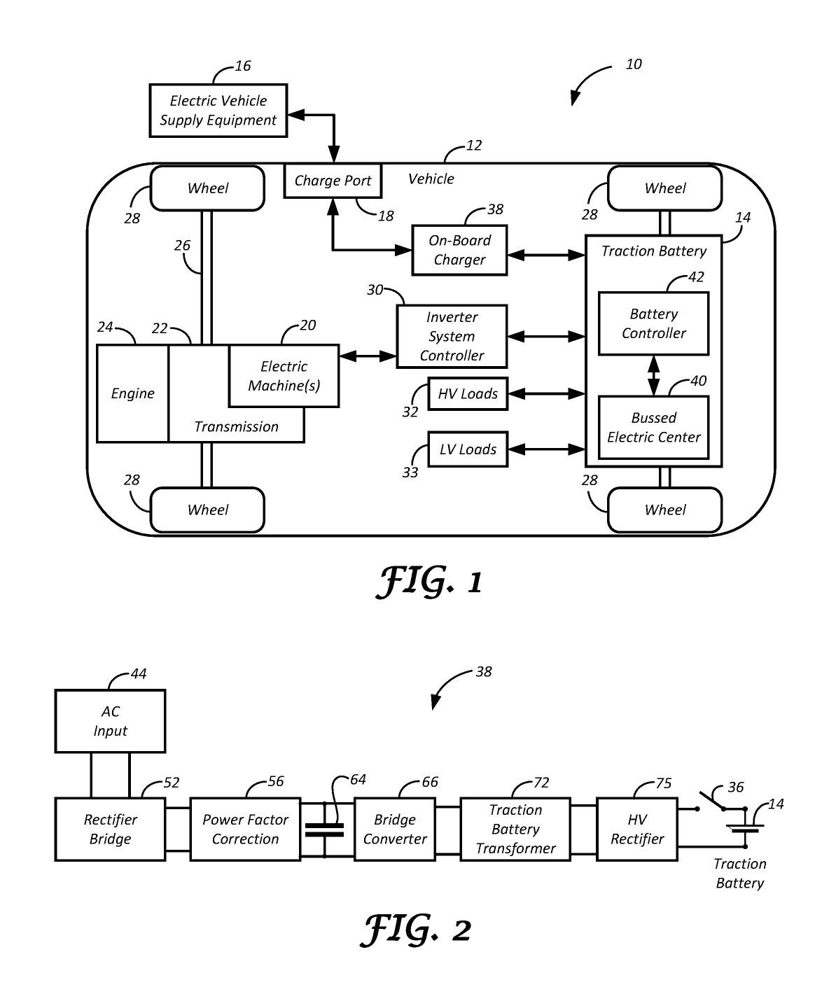

FIG. 1 depicts a plug-in hybrid-electric vehicle (PHEV) power system 10. A PHEV 12, hereinafter vehicle 12, may comprise a hybrid transmission 22 mechanically connected to an engine 24 and a drive shaft 26 driving wheels 28. The hybrid transmission 22 may also be mechanically connected to one or more electric machines 20 capable of operating as a motor or a generator. The electric machines 20 may be electrically connected to an inverter system controller (ISC) 30 providing bi-directional energy transfer between the electric machines 20 and at least one traction battery 14.

The traction battery 14 typically provides a high voltage (HV) direct current (DC) output. In a motor mode, the ISC 30 may convert the DC output provided by the traction battery 14 to a three-phase alternating current (AC) as may be required for proper functionality of the electric machines 20. In a regenerative mode, the ISC 30 may convert the three-phase AC output from the electric machines 20 acting as generators to the DC voltage required by the traction battery 14. In addition to providing energy for propulsion, the traction battery 14 may provide energy for high voltage loads 32, such as compressors and electric heaters, and low voltage loads 33, such as electrical accessories and/or an auxiliary 12V battery, hereinafter auxiliary battery, 34.

The vehicle 12 may be configured to recharge the traction battery 14 via a connection to a power grid (not shown). The vehicle 12 may, for example, cooperate with electric vehicle supply equipment (EVSE) 16 of a charging station to coordinate the charge transfer from the power grid to the traction battery 14. In one example, the EVSE 16 may have a charge connector for plugging into a charge port 18 of the vehicle 12, such as via connector pins that mate with corresponding recesses of the charge port 18. The charge port 18 may be electrically connected to an on-board power conversion controller or charger 38. The charger 38 may condition the power supplied from the EVSE 16 to provide the proper voltage and current levels to the traction battery 14. The charger 38 may interface with the EVSE 16 to coordinate the delivery of power to the vehicle 12.

The vehicle 12 may be designed to receive single- or three-phase AC power from the EVSE 16. The vehicle 12 may further be capable of receiving different levels of AC voltage including, but not limited to, Level 1 120 volt (V) AC charging, Level 2 240V AC charging, and so on. In one example, both the charge port 18 and the EVSE 16 may be configured to comply with industry standards pertaining to electrified vehicle charging, such as, but not limited to, Society of Automotive Engineers (SAE) J1772, J1773, J2954, International Organization for Standardization (ISO) 15118-1, 15118-2, 15118-3, the German DIN Specification 70121, and so on.

The traction battery 14 may comprise a plurality of battery cells (not shown), e.g., electrochemical cells, electrically connected to a bussed electric center (BEC) 40, for example, via a positive and a negative terminals. The BEC 40 may comprise a plurality of connectors and switches enabling the supply and withdrawal of electric energy to and from the battery cells via the positive and negative terminals. In one example, the BEC 40 includes a positive main contactor electrically connected to the positive terminal of the battery cells and a negative main contactor electrically connected to the negative terminal of the battery cells. Closing the positive and negative main contactors may enable the flow of electric energy to and from the battery cells. While the traction battery 14 is described herein as including electrochemical cells, other types of energy storage device implementations, such as capacitors, are also contemplated.

The battery controller 42 is electrically connected to the BEC 40 and controls the energy flow between the BEC 40 and the battery cells. For example, the battery controller 42 may be configured to monitor and manage temperature and state of charge of each of the battery cells. The battery controller 42 may command the BEC 40 to open or close one or more switches in response to temperature or state of charge in a given battery cell reaching a predetermined threshold. The battery controller 42 may be electrically connected to and in communication with one or more other vehicle controllers (not shown), such as an engine controller, a transmission controller, a body controller, and so on, and may command the BEC 40 to open or close one or more switches in response to a predetermined signal from the other vehicle controllers.

The battery controller 42 may be in communication with the charger 38. In one example, the charger 38 may comprise control logic configured to communicate with the battery controller 42 in controlling, or regulating, transfer of energy to the traction battery 14. The charger 38, using, for example, the control logic, sends a signal to the battery controller 42 indicative of a request to charge the traction battery 14. In one example, the charger 38 sends a signal indicative of a request to charge the traction battery 14 in response to determining that the charge port 18 has been connected to the EVSE 16. The battery controller 42 may then command the BEC 40 to open or close one or more switches, e.g., the positive and negative main contactors, enabling the transfer of electric energy between the EVSE 16 and the traction battery 14.

As will be described in further detail in reference to FIG. 3, the BEC 40 may include a pre-charge circuit 46 configured to control an energizing process of the positive terminal by delaying the closing of the positive main contactor until voltage level across the positive and negative terminals reached a predetermined threshold. Following the closing of the positive and negative main contactors, the transfer of electric energy may occur between the traction battery 14 and one or more components or systems, such as the EVSE 16, the electric machines 20, and/or the high and low voltage loads 32, 33.

While FIG. 1 depicts a plug-in hybrid electric vehicle, the description herein is equally applicable to a pure electric vehicle. For a pure electric vehicle, e.g., battery electric vehicle (BEV), the hybrid transmission 22 may be a gear box connected to the electric machine 20 and the engine 24 may not be present. The various components discussed may have one or more associated controllers to control and monitor the operation of the components. The controllers may communicate via a serial bus (e.g., Controller Area Network (CAN)) or via discrete conductors.

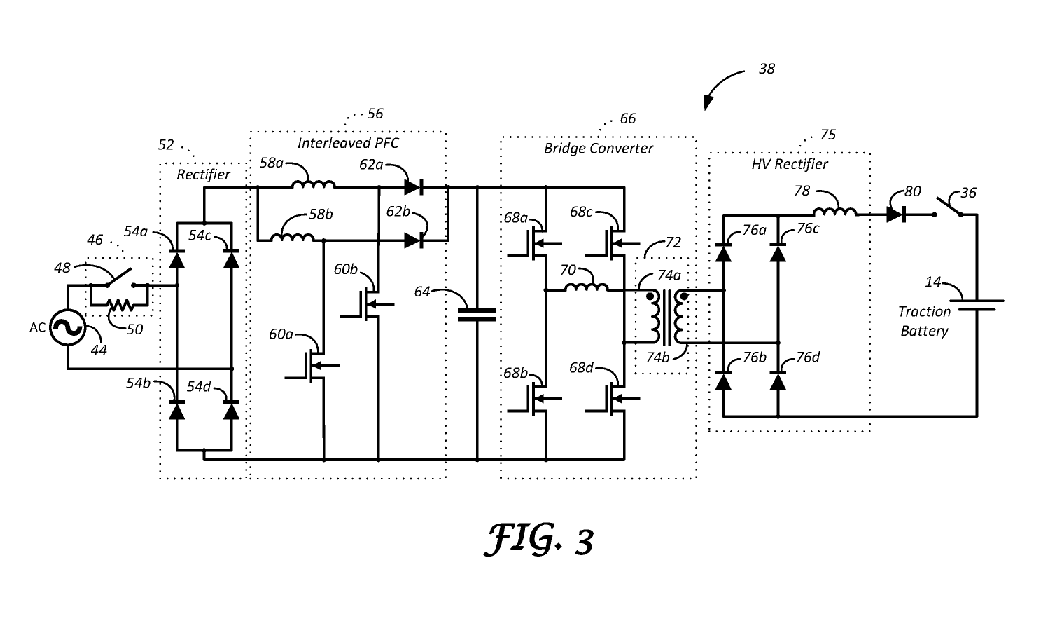

In reference to FIG. 2, an example of the charger 38 for charging the traction battery 14 is shown. The charger 38 may be configured to convert AC energy to DC energy suitable for charging the traction battery 14. In one example, the control logic of the charger 38 may be configured to control one or more power (conditioning and/or conversion) stages of the charger 38 to enable energy transfer to the traction battery 14. In response to detecting, for example, that the vehicle 12 has been connected to the EVSE 16, the control logic of the charger 38 may transmit a signal to the battery controller 42 indicative of a request to charge the traction battery 14. The battery controller 42 may then command the BEC 40 to open or close one or more switches (generally illustrated as a switch 36), e.g., the positive and negative main contactors, enabling the transfer of electric energy between the EVSE 16 and the traction battery 14. As described in further detail in reference to FIG. 3, one or more power stages of the charger 38 may be represented using active and/or passive electrical circuit components, programmable devices, or other implements.

The charger 38 may include a rectifier bridge 52 that rectifies, or converts, the AC power supplied by an AC power source 44, such as the EVSE 16, the power grid, and so on, to DC power. The charger 38 may correct a power factor 56 of the DC output of the rectifier bridge 52, such as by using a power factor correction circuit. In one example, a power factor of an electrical circuit may be a ratio expressing relative relationship of real, or true, power used by the circuit to do work and apparent power supplied to the circuit. A value of the power factor may range between zero (0) for a purely inductive load and one (1) for a purely resistive load. The charger 38 may further include a bulk capacitor 64 configured to transfer power to a bridge converter 66. The bridge converter 66 may convert output of the bulk capacitor 64 to a voltage level to be received by the traction battery 14.

A traction battery transformer 72 may be configured to transfer energy output by the bridge converter 66 to the traction battery 14 while providing galvanic isolation between the AC power source 44 and the traction battery 14. A high voltage (HV) rectifier 75 may be configured to receive AC output of the transformer 72 and to convert to DC for transferring to the traction battery 14. It should be noted that the charger 38 and the associated power stages are merely examples, and other arrangements or combinations of elements, stages, and components may be used. In one example, the transformer 72 and the bridge converter 66 may be part of a single electrical component.

Shown in FIG. 3 is a circuit diagram of the one or more power stages of the charger 38 for charging the traction battery 14 described in reference to FIG. 2. The charger 38 receives AC electrical energy from the AC power source 44, for example, via the charge port 18. A pre-charge circuit 46 of the charger 38 may include a pre-charge contactor 48 connected in series with a pre-charge resistor 50 and may be configured to control energizing process of one or more terminals of the traction battery 14 prior to closing the one or more switches 36. In one example, the pre-charge circuit 46 may be electrically connected in parallel with a positive main contactor. When the pre-charge contactor 48 is closed the positive main contactor may be open and the negative main contactor may be closed enabling the electric energy to flow through the pre-charge circuit 46 and control an energizing process of the positive terminal of the traction battery 14.

The charger 38 may further include the rectifier bridge 52 configured to rectify, i.e., convert, AC input voltage received from the AC power source 44 into DC output voltage for charging the traction battery 14. In one example, the rectifier bridge 52 may include a plurality of diodes 54a-d connected in series pairs such that during a positive half cycle of the input voltage the diodes 54b and 54c are conducting while the diodes 54a and 54d are reverse biased and during a negative half cycle the diodes 54a and 54d are conducting and the diodes 54b and 54c are reverse biased.

An interleaved power factor correction (PFC) circuit 56 of the charger 38 may be configured to reduce input current harmonics, such as input current ripple amplitude, thereby improving a power factor and increasing efficiency of the charger 38. In one example, the interleaved PFC circuit 56 is a two-cell interleaved boost converter. The interleaved PFC circuit 56 includes inductors 58a-b, high frequency switches 60a-b, and diodes 62a-b.

The switches 60a-b may be one or more semiconductor switches, such as metal-oxide semiconductor field-effect transistor (MOSFET), insulated gate bipolar transistors (IGBT), bipolar junction transistor (BJT), and so on. In one example, the switches 60a-b may be N-channel depletion type MOSFETs. The control logic of the charger 38 may command the switches 60a-b on and off with the same duty ratio, e.g., 50%, but time interleaved, i.e., with a relative phase shift of 180 degrees introduced between the commands to each of the respective switches 60a-b.

When the switches 60a-b are in a closed position the electric energy flowing through a corresponding one of the inductors 58a-b generates a magnetic field causing the inductor to store energy. When the switches 60a-b are in an open position the corresponding one of the inductors 58a-b charges a bulk capacitor 64 via a respective one of the diodes 62a-b. In one example, phase shifting the on and off commands issued to each of the switches 60a-b may reduce ripple in the output current of the inductors 58a-b.

The bulk capacitor 64 provides electrical energy to a next power stage of the charger 38 when one of the switches 60a-b is closed. In one example, the phase shift introduced between the on and off commands by the control logic of the charger 38 to each of the switches 60a-b enables the bulk capacitor 64 to produce a substantially constant output voltage level. In their reverse-biased state at a time when a corresponding one of the switches is closed the diodes 62a-b slow a discharge of the bulk capacitor 64.

The bridge converter 66 is configured to transfer power to the traction battery 14. In one example, the bridge converter 66 may be an isolated DC-DC converter equipped with a ferrite-core transformer 72 configured to provide galvanic isolation between the AC power source 44 and the traction battery 14. A plurality of high frequency switches 68a-d, e.g., MOSFETs, IGBTs, and/or BJTs, may be arranged in a full-bridge configuration on a primary side 74a of the transformer 72.

The control logic of the charger 38 may be configured to command the plurality of high frequency switches 68a-d on and off, such that the switches 68a, 68c are switched at 50% cycle and 180 degrees out of phase with each other and the switches 68b, 68d are also switched at 50% duty cycle and 180 degrees out of phase with each other. A resonance inductor 70 may be configured to control leakage inductance of the transformer 72 thereby providing resonance operation of the transformer 72 with capacitance of the switches 68a-d and facilitating zero voltage switching (ZVS).

The HV rectifier 75 includes a plurality of rectifier diodes 76a-d arranged in a full-bridge configuration on a secondary side 74b of the transformer 72. The rectifier diodes 76a-d may be configured to rectify, i.e., convert, the AC current output by the transformer 72. The charger 38 may further include a secondary side inductor 78 and a secondary side diode 80 configured to reduce current ripple output by the rectifier diodes 76a-d and to decrease the discharge of the traction battery 14, respectively.

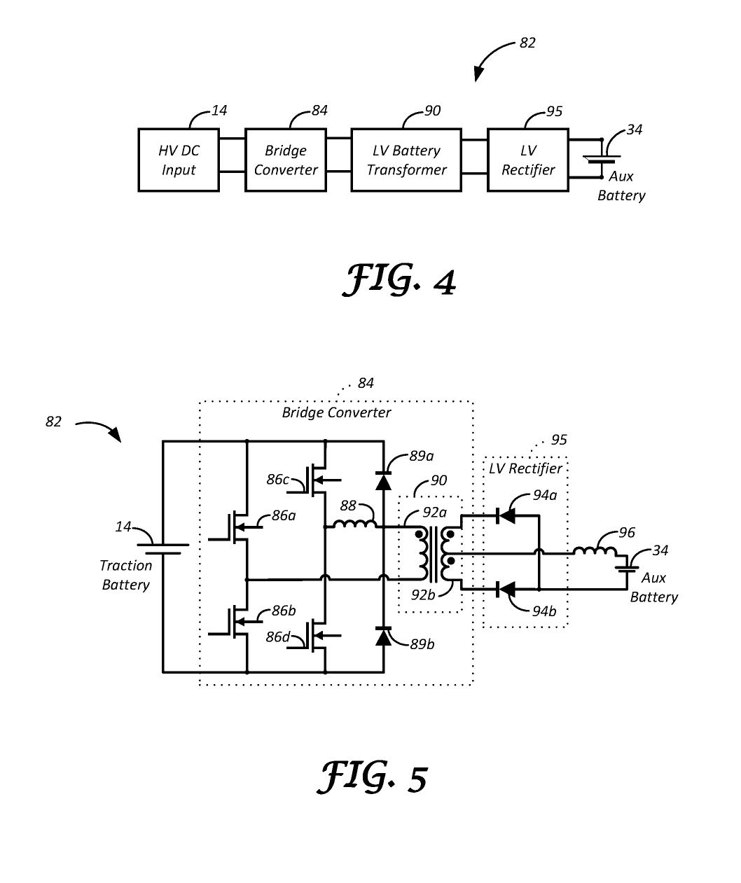

In reference to FIG. 4, an auxiliary battery charging system 82 is shown. The battery controller 42 may be configured to control transfer of energy to the auxiliary battery 34. In one example, the battery controller 42 may be configured to control converting high voltage DC output of the traction battery 14 to a level suitable for charging the auxiliary battery 34. As described in further detail in reference to FIG. 5, one or more power stages of the auxiliary battery charging system 82 may be represented using active and/or passive electrical circuit components, programmable devices, or other implements.

The auxiliary battery charging system 82 includes a bridge converter 84 configured to convert high voltage DC output of the traction battery 14 to a voltage level to be received by the auxiliary battery 34. A low voltage battery transformer 90 may be configured to transfer energy output by the bridge converter 84 to the auxiliary battery 34 while providing galvanic isolation between the traction battery 14 and the auxiliary battery 34. A low voltage rectifier 95 may be configured to receive AC output of the low voltage battery transformer 90 and convert it to DC voltage for transferring to the auxiliary battery 34.

Shown in FIG. 5 is a circuit diagram of the one or more power stages of the auxiliary battery charging system 82. The battery controller 42 may transmit one or more signals indicative of a command to charge the auxiliary battery 34. In one example, the battery controller 42 may command the charging of the auxiliary battery 34 in response to receiving from one or more vehicle controllers a signal indicating that voltage of the auxiliary battery 34 is below a predetermined threshold. In another example, the battery controller 42 may command the charging of the auxiliary battery 34 in response to receiving from one or more vehicle controllers and/or sensors a signal indicative of a request to charge the auxiliary battery 34.

The bridge converter 84 of the auxiliary battery charging system 82 converts high voltage DC output of the traction battery 14 to a low level DC voltage required by the auxiliary battery 34. The bridge converter 84 includes a plurality of high frequency switches 86a-d arranged in a full-bridge configuration. In one example, the bridge converter 84 may be an isolated DC-DC buck converter equipped with a ferrite-core transformer 90 configured to provide galvanic isolation between the traction battery 14 and the auxiliary battery 34. The plurality of high frequency switches 86a-d, e.g., MOSFETs, IGBTs, and/or BJTs, may be arranged on a primary side 92a of the transformer 90.

The battery controller 42 may be configured to command the plurality of high frequency switches 86a-d on and off, such that the switches 86a, 86c are switched at 50% cycle and 180 degrees out of phase with each other and the switches 86b, 86d are also switched at 50% duty cycle and 180 degrees out of phase with each other. A resonance inductor 88 and a pair of diodes 89a-b may be configured to control leakage inductance of the transformer 90 thereby providing resonance operation of the transformer 90 with capacitance of the switches 86a-d and facilitating ZVS. The low voltage rectifier 95 includes a plurality of diodes 94a-b arranged on a secondary side 92b of the transformer 90. The diodes 94a-b may be configured to rectify, i.e., convert, the AC current output by the transformer 90. The auxiliary battery charging system 82 may further include a secondary side inductor 96 configured to reduce current ripple output by the secondary side 92b of the transformer 90.

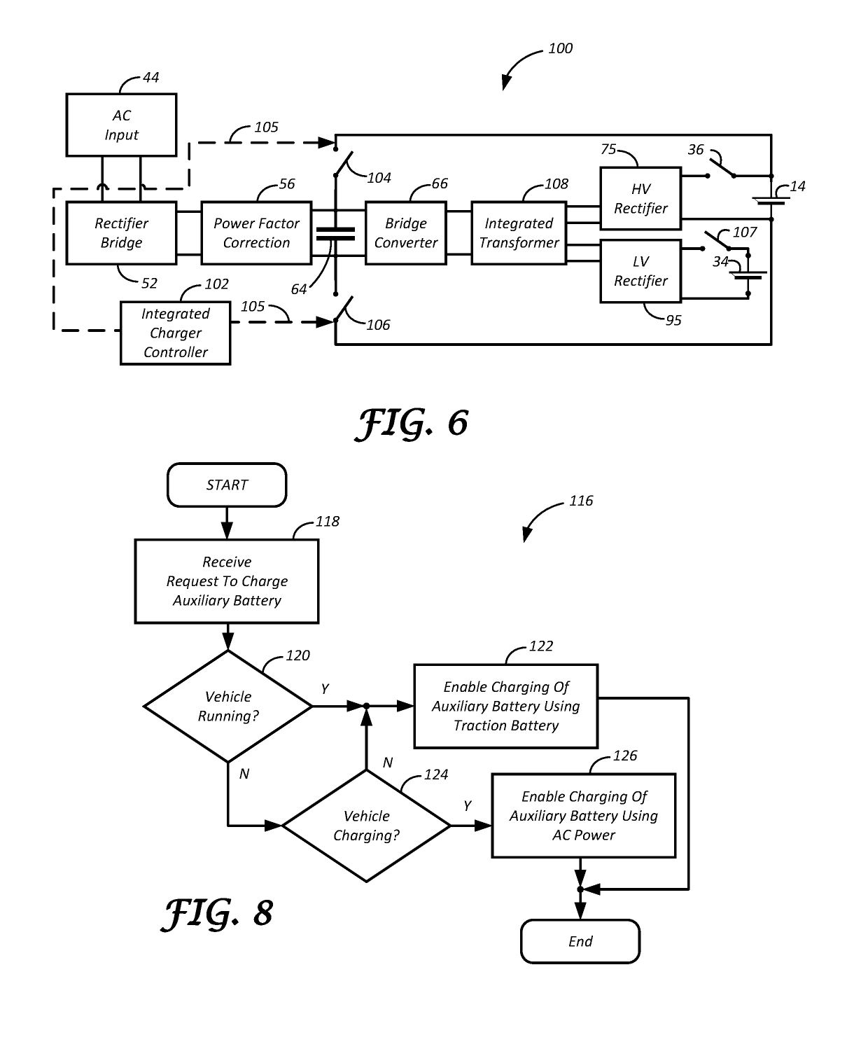

In reference to FIG. 6, an integrated charging system 100 for charging the traction battery 14 and the auxiliary battery 34 is shown. The integrated charging system 100 includes an integrated charger controller 102 configured to enable and disable charging of the traction battery 14 and/or the auxiliary battery 34 using AC power. In one example, the integrated charger controller 102 may command opening, e.g., via control lines 105 configured to energize and de-energize a relay or another type of electrical switch, a pair of switches 104 and 106 to enable charging of the traction battery 14 and/or the auxiliary battery 34 using AC power and command, e.g., via the control lines 105, closing of the switches 104, 106 to disable the AC charging.

The integrated charger controller 102 may command opening of the switches 104, 106 in response to determining that the charge port 18 has been connected to the power grid or to another power supply via, for example, the EVSE 16. In one example, the integrated charger controller 102 may be in communication with the battery controller 42 and may command opening of the switches 104, 106 in response to receiving a signal from the battery controller 42 indicating that the traction battery 14 can be charged, e.g., a pre-charge process is complete and/or the one or more switches 36 are closed.

The integrated charger controller 102 may open the switches 104, 106 and enable AC power flow to the traction battery 14 and/or the auxiliary battery 34 via power stages such as, for example, power stages described in reference to at least FIGS. 2-5. In one example, in response to the opening of the switches 104, 106, the rectifier bridge 52 receiving AC power from the AC power source 44 rectifies it to DC power and the power factor correction circuit 56 corrects the power factor of the output of the rectifier bridge 52.

The bulk capacitor 64 may be inactive, i.e., not supplying energy, when the switches 104, 106 are open. The bridge converter 66, as described in reference to at least FIGS. 2-5, converts output of the power factor correction circuit 56 and energizes an integrated transformer 108. The integrated charger controller 102 may be configured to selectively enable charge flow to the traction battery 14 and/or the auxiliary battery 34 via the integrated transformer 108.

The integrated charger controller 102 may be configured to selectively enable and disable, such as by commanding opening or closing of an auxiliary switch 107, charging of the auxiliary battery 34 while the traction battery 14 is being charged. For example, the integrated charger controller 102 may command closing of an auxiliary switch 107 to enable charging of the auxiliary battery 34 via the integrated transformer 108 and may command opening of the auxiliary switch 107 to disable the charging of the auxiliary battery 34 via the integrated transformer 108. In another example, the integrated charger controller 102 may enable and disable charge flow to the auxiliary battery 34 at a same time as the traction battery 14 is being charged in response to receiving a predetermined command or request from the one or more other vehicle controllers. In still another example, the integrated charger controller 102 may enable and disable charge flow to the auxiliary battery 34 via the integrated transformer 108 while (or at a same time as) the traction battery 14 is being charged in response to determining that voltage of the auxiliary battery 34 is above or below a predetermined threshold.

The integrated charger controller 102 may command closing of the switches 104, 106 and the auxiliary switch 107 in response to a predetermined command or request from the one or more other vehicle controllers. In one example, the integrated charger controller 102 commands closing of the switches 104, 106 and the auxiliary switch 107 in response to receiving a signal indicative of a request to charge the auxiliary battery 34 at a time when the vehicle 12 is not connected to the AC power source 44. In another example, in response to determining that voltage of the auxiliary battery 34 is below a predetermined threshold, the integrated charger controller 102 commands closing the switches 104, 106 and the auxiliary switch 107 enabling the auxiliary battery 34 to be charged using the DC output of the traction battery 14 at a time when the vehicle 12 is not receiving charge from the AC power source 44.

Closing of the switches 104, 106 may disable energy flow through the rectifier bridge 52 and the power factor correction circuit 56. Closing of the switches 104, 106 may enable energy flow through the bulk capacitor 64 such that, following, for example, the closing of the auxiliary switch 107, the auxiliary battery 34 may be charged using DC output of the traction battery 14. The bridge converter 66, as described in reference to at least FIGS. 2-5, converts output of the bulk capacitor 64. The bridge converter 66 is further configured to selectively energize the low voltage rectifier 95 and enable charge flow between the traction battery 14 and the auxiliary battery 34 via the integrated transformer 108 following, for example, the closing of the auxiliary switch 107.

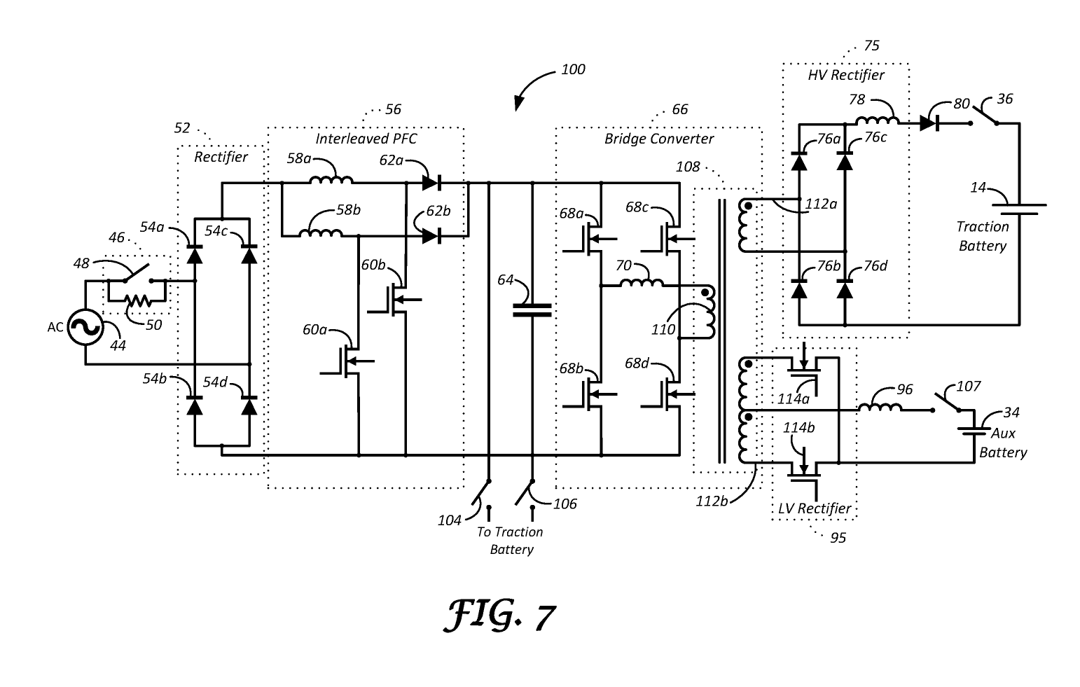

In reference to FIG. 7, a circuit diagram of the one or more power stages of the integrated charging system 100 for charging the traction battery 14 and the auxiliary battery 34 is shown. As described in reference to at least FIG. 6, the integrated charger controller 102 may be configured to enable and disable, such as by opening or closing the switches 104, 106, charging of the traction battery 14 and/or the auxiliary battery 34 using AC power. In one example, the integrated charger controller 102 may command, e.g., via the control lines 105, opening of a pair of switches 104 and 106 to enable charging of the traction battery 14 and/or the auxiliary battery 34 using AC power and command closing of the switches 104, 106 to disable the AC charging of the batteries.

The integrated charger controller 102 may command opening of the switches 104, 106 in response to determining that the charge port 18 has been connected to the power grid or to another power supply via, for example, the EVSE 16. Opening of the switches 104, 106 may deactivate, i.e., prevent energy flow through, the bulk capacitor 64. The integrated charger controller 102 may control the plurality of high frequency switches 68a-d, e.g., MOSFETs, IGBTs, and/or BJTs, arranged in a full-bridge configuration on a primary side 110 of the integrated transformer 108.

The transformer 108 may include a traction secondary side 112a transferring energy to the traction battery 14 and an auxiliary secondary side 112b transferring energy to the auxiliary battery 34. In one example, the integrated charger controller 102 may be configured to selectively enable energy flow to the traction battery 14 and/or the auxiliary battery 34 via a corresponding secondary side the integrated transformer 108 in response to a predetermined command or request.

In one example, the integrated charger controller 102 may enable energy flow to the auxiliary battery 34 via the auxiliary secondary side 112b of the integrated transformer 108 in response to receiving a predetermined command or request from the one or more other vehicle controllers and at a same time as the traction battery 14 is being charged. In another example, the integrated charger controller 102 may enable energy flow to the auxiliary battery 34 via the auxiliary secondary side 112b of the integrated transformer 108 at a same time as the traction battery 14 is being charged in response to determining that voltage of the auxiliary battery 34 is below a predetermined threshold. In such an example, the integrated charger controller 102 may control a pair of synchronous switches 114a-b of the low voltage rectifier 95 to enable energy flow to the auxiliary battery 34. The integrated charger controller 102 may further command closing of the auxiliary switch 107 to enable energy flow to the auxiliary battery 34 at a same time as the traction battery 14 is being charged.

The integrated charger controller 102 may command closing of the switches 104, 106 and command closing of the auxiliary switch 107 to enable energy flow between the traction battery 14 and the auxiliary battery 34 in response to a predetermined command or request from one or more other vehicle controllers, such as in response to a request to charge the auxiliary battery 34 at a time when the vehicle 12 is not connected to the AC power source 44 and/or in response to determining that voltage of the auxiliary battery 34 is below a predetermined threshold.

Closing of the switches 104, 106 may disable energy flow through the rectifier bridge 52 and the power factor correction circuit 56. Closing of the switches 104, 106 may enable energy flow through the bulk capacitor 64 such that the auxiliary battery 34 may be charged using DC output of the traction battery 14 following, for example, the closing of the auxiliary switch 107. In one example, the integrated charger controller 102 may control the plurality of high frequency switches 68a-d, e.g., MOSFETs, IGBTs, and/or BJTs, arranged in a full-bridge configuration on the primary side 110 of the integrated transformer 108. The integrated charger controller 102 may be further configured to selectively energize the synchronous switches 114a-b of the low voltage rectifier 95 to enable energy flow between the traction battery 14 and the auxiliary battery 34 via the auxiliary secondary side 112b of the integrated transformer following, for example, the closing of the auxiliary switch 107.

In reference to FIG. 8, an integrated charging process 116 is shown. The charging process 116 may begin at block 118 where the integrated charger controller 102 receives a signal indicative of a request to charge the auxiliary battery 34. At block 120 the integrated charger controller 102 determines whether the vehicle 12 is running. In one example, the integrated charger controller 102 may determine that the vehicle 12 is running in response to receiving a signal indicating one or more vehicle operating conditions, such as, but not limited to, the engine 24 is on, the vehicle speed is greater than a predetermined threshold, the one or more electric machines 20 are on, and so on. The integrated charger controller 102 at block 122 enables charging of the auxiliary battery 34 using DC output of the traction battery 14 in response to determining at block 120 that the vehicle 12 is running. In one example, the integrated charger controller 102 may command closing of the switches 104, 106 and command closing of the auxiliary switch 107 to enable energy flow between the traction battery 14 and the auxiliary battery 34. The integrated charger controller 102 may then exit the integrated charging process 116.

In response to determining at block 120 that the vehicle 12 is not running, e.g., the engine 24 is off, the vehicle speed is less than a predetermined threshold, and/or the one or more electric machines 20 are off, and so on, the integrated charger controller 102 at block 124 determines whether the vehicle 12 is charging. In one example, the integrated charger controller 102 may determine that the vehicle 12 is charging in response to receiving a signal indicating one or more vehicle operating conditions, such as, but not limited to, the charge port 18 is connected to the EVSE 16, and so on. The integrated charger controller 102 at block 122 enables charging of the auxiliary battery 34 using DC output of the traction battery 14 in response to determining at block 118 that the vehicle 12 is not charging. In one example, the integrated charger controller 102 may command closing of the switches 104, 106 and command closing of the auxiliary switch 107 to enable energy flow between the traction battery 14 and the auxiliary battery 34. The integrated charger controller 102 may then exit the integrated charging process 116.

In response to determining at block 124 that the vehicle 12 is charging, e.g., the charge port 18 is connected to the EVSE 16, the integrated charger controller 102 at block 126 enables charging of the auxiliary battery 34 using AC power from the AC power supply. In one example, the integrated charger controller 102 may control the synchronous switches 114a-b of the low voltage rectifier 95 and command closing of the auxiliary switch 107 to enable charging of the auxiliary battery 34 via the auxiliary secondary side 112b of the integrated transformer 108 at a same time as the traction battery 14 is being charged. At this point the integrated charging process 116 may end. In some embodiments the integrated charging process 116 described in reference to FIG. 8 may be repeated in response to receiving a signal indicative of a request to charge the auxiliary battery 34 or in response to another notification or request.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle power system comprising:
circuitry including a transformer having a single primary coil and at least two secondary coils electrically isolated from one another, one of the secondary coils being electrically connected to a traction battery and another of the secondary coils being electrically connected to an auxiliary battery; and
a controller configured to operate the circuitry to transfer power from the primary coil to each of the batteries at a same time.

2. The system of claim 1, wherein the controller is further configured to operate the circuitry to transfer power from the traction battery to the auxiliary battery via the transformer.

3. The system of claim 1, wherein the controller is further configured to operate the circuitry to transfer power from the primary coil to the traction battery without transferring power to the auxiliary battery.

4. The system of claim 1, wherein the controller is further configured to operate the circuitry to transfer power from the primary coil to the auxiliary battery without transferring power to the traction battery.

5. The system of claim 1, wherein the transferring includes, while transferring power to the traction battery, enabling transferring of power to the auxiliary battery responsive to a signal indicative of auxiliary battery voltage being below a predetermined threshold.

6. The system of claim 1, wherein the controller is further configured to operate the circuitry to invert power from alternating current (AC) power to direct current (DC) power prior to the transferring.

7. The system of claim 6, wherein the controller is further configured to operate the circuitry to increase a power factor of the inverted power prior to the transferring.

8. A method for charging batteries of a vehicle comprising:
cycling (i) switches electrically connected between a power source remote from the vehicle and a transformer having a single primary coil and at least two secondary coils electrically isolated from one another, one of the secondary coils being electrically connected to a traction battery and another of the secondary coils being electrically connected to an auxiliary battery, and (ii) switches electrically connected between the another of the secondary coils and the auxiliary battery to transfer power from the primary coil to each of the batteries at a same time.

9. The method of claim 8 further comprising cycling the switches electrically connected between the power source and the transformer to transfer power from the traction battery to the auxiliary battery via the transformer.

10. The method of claim 8 further comprising cycling the switches electrically connected between the another of the secondary coils and the auxiliary battery to transfer power from the primary coil to the traction battery without transferring power to the auxiliary battery.

11. The method of claim 8 further comprising cycling the switches electrically connected between the another of the secondary coils and the auxiliary battery to transfer power from the primary coil to the auxiliary battery without transferring power to the traction battery.

12. The method of claim 8 further comprising cycling the switches electrically connected between the power source and the transformer to invert power received from the power source from alternating current (AC) power to direct current (DC) power prior to the transferring.

13. The method of claim 12 further comprising cycling the switches electrically connected between the power source and the transformer to increase a power factor of the inverted power prior to the transferring.

14. The method of claim 13, wherein the cycling the switches electrically connected between the power source and the transformer to increase the power factor includes cycling at least two of the switches at a same frequency and at a phase offset of 180 degrees from each other.

15. A vehicle power system comprising:
a transformer having a single input and dual outputs electrically isolated from each other;
a traction battery electrically connected to one of the outputs; and
an auxiliary battery electrically connected to the other of the outputs, wherein the transformer is configured to transfer power from the input to each of the outputs at a same time.

16. The system of claim 15, wherein the transformer is further configured to transfer power from the one of the outputs to the other of the outputs.

17. The system of claim 16, wherein the transformer is electrically connected to a pair of switches and is further configured to transfer power from one of the outputs to the other of the outputs in response to closing of the pair of switches.

18. The system of claim 15, wherein the transformer is further configured to transfer power to the one of the outputs without transferring power to the other of the outputs.

19. The system of claim 18, wherein the input is electrically connected to a pair of switches and the transformer is further configured to transfer power to the one of the outputs without transferring power to the other of the outputs in response to the pair of switches being open.

20. The system of claim 15, wherein the other of the outputs is further electrically connected to an auxiliary battery switch and the transformer is further configured to transfer power to each of the outputs at a same time in response to closing of the auxiliary battery switch at a time when the one of the outputs is receiving power.
